(19) United States
(12) Patent Application Publication
(10) Pub. No.: US 2019/0036837 A1
(43) Pub. Date: Jan. 31, 2019

(54) PROACTIVE RESOURCE ACQUISITION FACILITATION

(71) Applicant: BANK OF AMERICA CORPORATION, Charlotte, NC (US)

(72) Inventors: Kathleen Miranda Brand, Charlotte, NC (US); William Bradley Burks, Charlotte, NC (US)

(21) Appl. No.: 15/661,250

(22) Filed: Jul. 27, 2017

(51) Int. Cl. H04L 12/911

(52) U.S. Cl. CPC H04L 47/72; H04L 67/306

(57) ABSTRACT

Embodiments of the present invention provide a system for facilitating proactive resource acquisition and improving the computer processing efficiency and store requirements of the resource entity systems. The system is configured for identifying one or more interactions for a user and scheduling the one or more interactions for a future time period, determining resource availability for the one or more interactions before the future time period, initiating the one or more interactions by communicating directly with at least one interaction entity before the future time period without processing the one or more interactions through an interchange network, and completing the one or more interactions with the at least one interaction entity at the future time period.

### FIELD

The present invention relates generally to processing one or more interactions associated with resource acquisition in an efficient manner without the involvement of third party entities.

### BACKGROUND

Sending notifications to uses requires large quantities of data storage and large amounts of processing capacity. When an entity sends targeted notifications to users, there is a greater likelihood that the users actually take an action associated with the notification, and it reduces the amount of data storage and processing capacity required when compared to non-targeted notification. By sending notifications to a subset of users from a plurality of users (excluding other users), an entity reduce the data and storage and processing capacity without affecting the actions taken on such notifications. Therefore, there is a need for a system to more accurately and efficiently provide notifications.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Generally, systems, computer products, and methods are described herein for facilitating proactive resource acquisition. More particularly, embodiments of the invention are related to identifying one or more interactions for a user and automatically schedule the one or more interactions for a future time period, identifying at least one interaction entity associated with the one or more interactions, determining resource availability for the one or more interactions before the future time period, authorizing the one or more interactions before the future time period when the resource availability is verified, allocating a resource amount for the one or more interactions from at least one resource pool of the user, establishing a communication link with the at least one interaction entity associated with the one or more interactions, wherein the communication link is established through at least one interaction entity system, initiating the one or more interactions by communicating directly with the at least one interaction entity before the future time period without processing the one or more interactions through an interchange network, and completing the one or more interactions with the at least one interaction entity at the future time period.

In further accord with embodiments of the invention, initiating the one or more interactions comprises: assigning a token to the at least one resource pool of the user to present to the at least one interaction entity in order to complete the one or more interactions.

In other embodiments of the invention, the invention further comprises completing the one or more interactions with the at least one interaction entity by transferring the resource amount from the at least one resource pool of the user to the at least one interaction entity before or at the future time period, receiving an indication of receipt of the resource amount and fulfillment of the one or more interactions from the at least one interaction entity, and in response to receiving the indication, transmitting a notification of fulfillment of the one or more interactions to a user computer system of the user.

In yet other embodiments of the invention, the invention further comprises completing the one or more interactions with the at least one interaction entity further by applying a supplemental resource amount for supplemental resources to the resource pool of the user, wherein the supplemental resources are specific to the user and associated with the one or more interactions.

In other embodiments, completing the one or more interactions with the at least one interaction entity at the future time period comprises transferring the resource amount reduced by a supplemental resource amount from the resource pool of the user, wherein the supplemental resource amount is associated with the one or more interactions and is specific to the user.

In further accord with embodiments of the invention, identifying the one or more interactions for the user comprises determining that the one or more interactions require an indication from the user for automatically entering into the one or more interactions, prompting the user on a user computer system to provide the indication for automatically entering into the one or more interactions, and receiving the indication from the user to allow for automatically entering into the one or more interactions.

In further accord with embodiments of the invention, the invention further comprises sending an initiated interaction notification to a user computer system of the user when the one or more interactions are scheduled, sending a pending interaction notification to the user computer system of the user before meeting the future time period, and sending a completed interaction notification to the user computer system of the user before the meeting the future time period of the interaction.

In some embodiments, the one or more interactions include at least one of one or more desired interactions or one or more suggested interactions.

In some embodiments, the one or more desired interactions are received as an input from the user.

In some embodiments, the one or more suggested interactions are based on the one or more desired interactions, one or more available interactions, and plurality of previous interactions.

In some embodiments, information associated with the one or more available interactions and the plurality of previous interactions is provided by the at least one interaction entity.

In alternate embodiments, the information associated with the plurality of previous interactions is extracted from a user profile.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, where:

FIG. 1 illustrates a block diagram of a supplemental resource system, in accordance with embodiments of the present invention.

FIG. 2 illustrates a flowchart for a general process flow for utilizing supplemental resources, in accordance with embodiments of the present invention.

FIG. 3 illustrates flowchart for a process flow for determining interactions for a user based in part on desired interactions and supplemental resources, in accordance with embodiments of the present invention.

FIG. 4 illustrates an interface for a desired interaction list, in accordance with embodiments of the present invention.

FIG. 5 illustrates a prior art system for processing and finalizing interactions.

FIG. 6 illustrates a block diagram of a system facilitating proactive resource acquisition, in accordance with embodiments of the present invention.

FIG. 7A illustrates flowchart for a process flow for facilitating proactive resource acquisition, in accordance with embodiments of the present invention.

FIG. 7B illustrates flowchart for a process flow for initiating and completing one or more interactions associated with resource acquisition, in accordance with embodiments of the present invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Systems, methods, and computer program products are herein disclosed that facilitate proactive resource acquisition, which improves the processing efficiency and storage requirements, as well as allowing for improved interactions over the internet. Typically, the prior art systems take two or three days to process and finalize interactions, which involves third party entities acting as intermediaries between interaction and resource entities, thereby decreasing the processing efficiency of the resource entity systems. Involvement of third party entities in the processing of the transactions requires additional tracking and documentation of each step of the process, thereby increasing the memory consumption of the resource entity system. The present invention solves the problem by eliminating the need for third party entities to act as an intermediary. The system of the present invention facilitates improved resource acquisition and improved interactions for the user, which also results in the improved computer processing efficiency and storage of the resource entity systems. Additionally, the present invention also provides a unique way to help the interaction entity to fulfill the interactions efficiently, thereby improving the computer processing efficiency of the interaction entity systems.

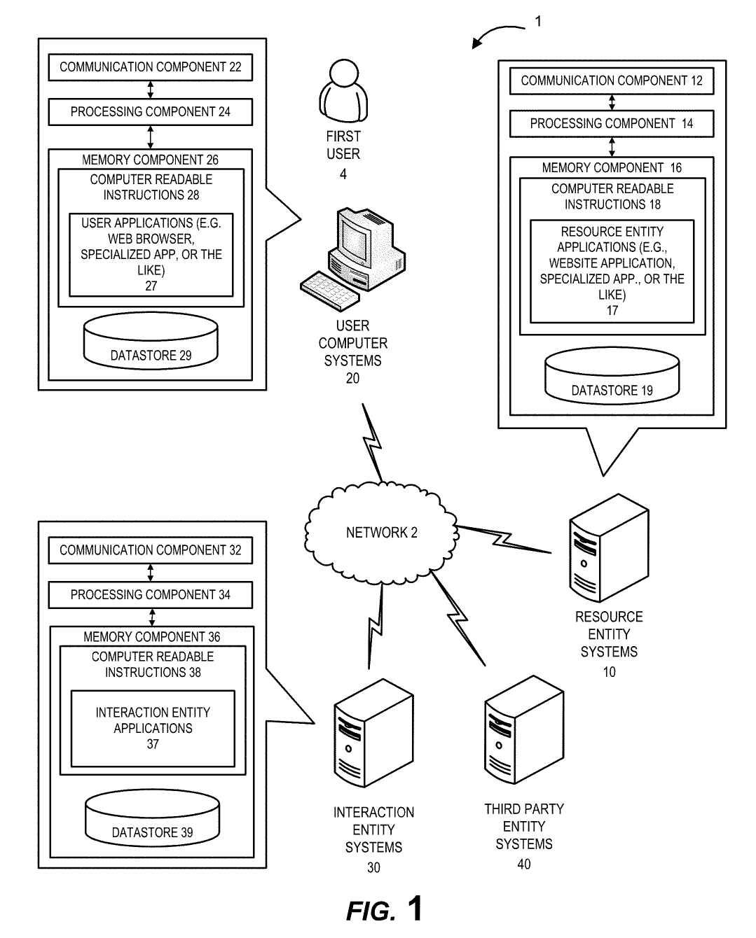

FIG. 1 illustrates a supplemental resource system environment 1, in accordance with embodiments of the invention. As illustrated in FIG. 1, one or more resource entity systems 10 are operatively coupled, via a network 2, to one or more user computer systems 20, one or more interaction entity systems 30, one or more third-party systems 40, and/or one or more other systems (not illustrated). In this way, the user 4 (e.g., one or more associates, employees, agents, contractors, sub-contractors, third-party representatives, customers, or the like), through a user application 27 (e.g., web browser, dedicated or specialized application, or the like), may access resource entity applications 17 (e.g., website, dedicated or specialized application, or the like) of the resource entity systems 10 to receive supplemental resources for interactions with interaction entities.

The network 2 may be a global area network (GAN), such as the Internet, a wide area network (WAN), a local area network (LAN), or any other type of network or combination of networks. The network 2 may provide for wireline, wireless, or a combination of wireline and wireless communication between systems, services, components, and/or devices on the network 2.

As illustrated in FIG. 1, the resource entity systems 10 generally comprise one or more communication components 12, one or more processing components 14, and one or more memory components 16. The one or more processing components 14 are operatively coupled to the one or more communication components 12 and the one or more memory components 16. As used herein, the term “processing component” generally includes circuitry used for implementing the communication and/or logic functions of a particular system. For example, a processing component 14 may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more processing components 14 may include functionality to operate one or more software programs based on computer-readable instructions 18 thereof, which may be stored in the one or more memory components 16.

The one or more processing components 14 use the one or more communication components 12 to communicate with the network 2 and other components on the network 2, such as, but not limited to, the components of the user computer systems 20, the interaction entity systems 30, third-party systems 40, or other systems. As such, the one or more communication components 12 generally comprise a wireless transceiver, modem, server, electrical connection, electrical circuit, or other component for communicating with other components on the network 2. The one or more communication components 12 may further include an interface that accepts one or more network interface cards, ports for connection of network components, Universal Serial Bus (USB) connectors and the like.

As further illustrated in FIG. 1, the resource entity systems 10 comprise computer-readable instructions 18 stored in the memory component 16, which in one embodiment includes the computer-readable instructions 18 of the resource entity application 17 (e.g., website application, dedicated application, or the like). In some embodiments, the one or more memory components 16 include one or more data stores 19 for storing data related to the resource entity systems 10, including, but not limited to, data created, accessed, and/or used by the resource entity application 17. The resource entity application 17 may be utilized to provide and/or store not only resources for the user 4, but also supplemental resources for the user, and apply such supplemental resources to the interactions of the user 4.

As illustrated in FIG. 1, users 4 may access the resource entity application 17, or other applications, through a user computer system 20. The user computer system 20 may be a desktop, mobile device (e.g., laptop, smartphone device, PDA, tablet, or other mobile device), or any other type of computer that generally comprises one or more communication components 22, one or more processing components 24, and one or more memory components 26.

The one or more processing components 24 are operatively coupled to the one or more communication components 22, the one or more image capture components 25, and the one or more memory components 26. The one or more processing components 24 use the one or more communication components 22 to communicate with the network 2 and other components on the network 2, such as, but not limited to, the resource entity systems 10, the interaction entity systems 30, third-party systems 40, and/or other systems. As such, the one or more communication components 22 generally comprise a wireless transceiver, modem, server, electrical connection, or other component for communicating with other components on the network 2. The one or more communication components 22 may further include an interface that accepts one or more network interface cards, ports for connection of network components, Universal Serial Bus (USB) connectors and the like. Moreover, the one or more communication components 22 may include a keypad, keyboard, touch-screen, touchpad, microphone, mouse, joystick, other pointer component, button, soft key, and/or other input/output component(s) for communicating with the users 4.

As illustrated in FIG. 1, the user computer systems 20 may have computer-readable instructions 28 stored in the one or more memory components 26, which in one embodiment includes the computer-readable instructions 28 for user applications 27, such as dedicated applications (e.g., apps, applet, or the like), portions of dedicated applications, a web browser or other apps that allow the user 4 to take various actions, including allowing the user 4 to access applications located on other systems, or the like. In some embodiments, the user 4 utilizes the user applications 27, through the user computer systems 20, to access the resource entity applications 17 to accept supplemental resources. Moreover, in some embodiments the user 4 may also utilize the user applications 27, through the user computer systems 20, to enter into interactions with the interaction entity, through the interaction entity applications 37 and/or interaction entity systems 30.

As illustrated in FIG. 1, one or more interaction entity systems 30 may communicate with the resource entity systems 10 and/or user computer systems 20 to provide supplemental resources to the resource entity and/or to engage in interactions with the user 4. As such, the interaction entity systems 30 are operatively coupled, via a network 2, to the one or more resource entity systems 10, the user computer systems 20, the third party systems 40, and/or other systems. The interaction entity systems 30 generally comprise one or more communication components 32, one or more processing components 34, and one or more memory components 36.

The one or more processing components 34 are operatively coupled to the one or more communication components 32, and the one or more memory components 36. The one or more processing components 34 use the one or more communication components 32 to communicate with the network 2 and other components on the network 2, such as, but not limited to, the components of the resource entity systems 10, the user computer systems 20, the third party systems 40, and/or other systems. As such, the one or more communication components 32 generally comprise a wireless transceiver, modem, server, electrical connection, or other component for communicating with other components on the network 2. The one or more communication components 32 may further include an interface that accepts one or more network interface cards, ports for connection of network components, Universal Serial Bus (USB) connectors and the like.

As illustrated in FIG. 1, the interaction entity systems 30 may have computer-readable instructions 38 stored in the one or more memory components 36, which in one embodiment includes the computer-readable instructions 38 of interaction entity applications 37 that allow for the interactions with the user 4 and/or the resource entity regarding supplemental resources, as will be described herein.

Moreover, as illustrated in FIG. 1, third party entity systems 40, and/or other like systems are operatively coupled to the resource entity systems 10, the user computer systems 20, and/or the interaction entity systems 30, through the network 2. The third party entity systems 40 and/or other like systems have components the same as or similar to the components described with respect to the resource entity systems 10, the user computer systems 20, and/or the interaction entity systems 30 (e.g., one or more communication components, one or more processing components, and one or more memory devices with computer-readable instructions of one or more applications, one or more datastores, or the like). Thus, the third party systems 40 and/or other like systems communicate with the resource entity systems 10, the user computer systems 20, the interaction entity systems 30, and/or each other in same or similar way as previously described with respect to the resource entity systems 10, the user computer systems 20, and/or the interaction entity systems 30.

The present invention disclosed herein relates generally to a resource entity providing a notification to a user that results in the user being able to take an action, such that a user may enter into a future interaction using user's resources from a resource pool and supplemental resources related to the notification and/or action. In some embodiments, the resource entity may be a financial institution and the interaction entity may be a merchant, but it should be understood that the entities may be another third party entity acting on its own or as a third-party for the resource entity or interaction entity. In some embodiments, the resource entity or the interaction entity may be acting on behalf of one another.

The notification may relate to supplemental resources (e.g., and offer, discount, rebate, or the like) that the user may utilize for a product (e.g., good or service) during an interaction (e.g., transaction, or the like) with an interaction entity. The notification may be presented to the user via various channels, such as through the user's online resource pool (e.g., online banking account, or the like), social network account, email, text message, or other like channel. In some embodiments, the user action may be the acceptance of the supplemental resources provided in the notification. When the user accepts the supplemental resources, the supplemental resources are activated so that if the user uses eligible resources from an eligible resource pool (e.g., as determined by the resource entity, the interaction entity, third party entity, or the like) to enter into the interaction, the user receives the benefit associated with the supplemental resources. In other embodiments, the supplemental resources may be automatically activated if the user has previously chosen to automatically activate supplemental resources associated with particular interactions (e.g., associated with particular interaction entities or products). In some embodiments, the resource entity may determine that a user may choose among multiple eligible resources pools in order to enter into an interaction associated with the supplemental resources. As will be described in further detail later, in some embodiments the present invention provides a targeted integrated interface that integrates information related to interactions that the user 4 has with interaction entities with resources used from the resource entities, and provides targeted supplemental resources to the user 4 through the targeted integrated interface.

The present invention provides at least three different improvements to the technological environment of interactions that occur over a network 2, such as the Internet. First, the present invention presents a targeted integrated interface that presents targeted supplemental resources to the user 4 in order to keep the user 4 within the resource entity systems 10 and to make the user 4 more likely to use the resources of the resource entity by providing supplemental resources to the user 4 for future interactions with various interaction entity systems 30. Secondly, the present invention allows a user to utilize a desired interaction list (e.g., a desired interaction integrated interface, or the like) with which the user 4 may include the user's desired interactions, and in some cases pre-approval limits, that allow the resource entity to automatically enter into interactions on behalf of the user 4. By allowing the resource entity to enter into interactions on behalf of the user 4, the resource entity receives a benefit in that it keeps the user 4 using the resources the user 4 has with the resource entity, and the user 4 also receives a benefit in that the user 4 is entering into interactions on the user's desired terms when the interactions become available and are most favorable to the user. Finally, the present invention improves the processing efficiency and reduces the storage capacity required by the resource entity systems 10 to present the targeted supplemental resources to the users 4. Because the targeted integrated interface is utilized to present the targeted supplemental resources to the user 4, the number of notifications presented to users 4 is greatly reduced because the notifications are specific to the user 4 and the user 4 can select the targeted supplemented resources that the user 4 wants to use as the user's convenience.

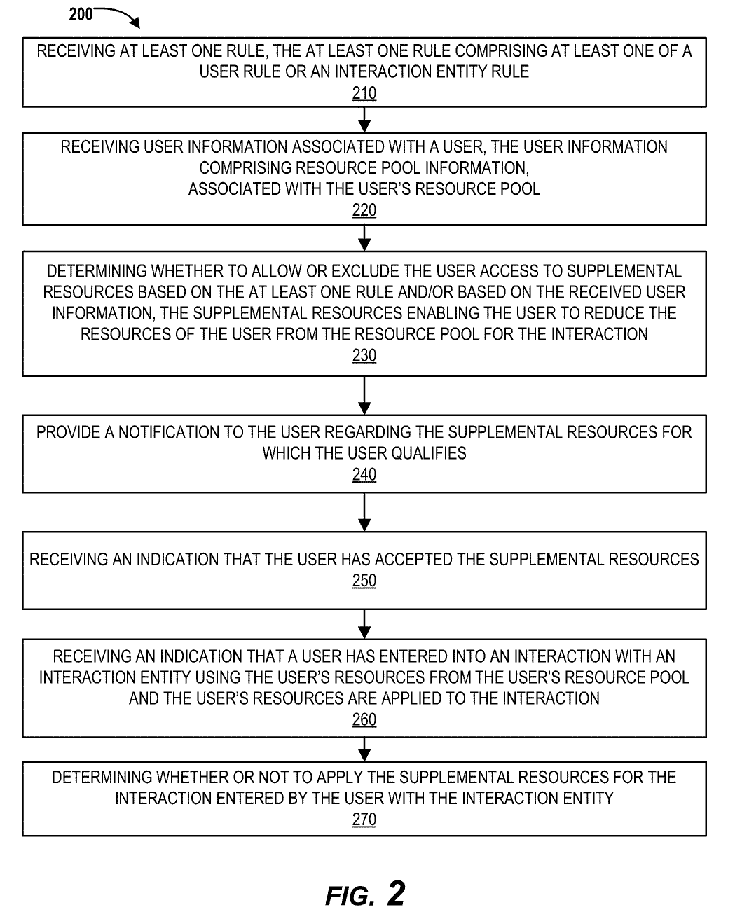

Referring now to FIG. 2, a general process flow 200 is provided for implementing rule-based supplemental resource association. At block 210, the method comprises receiving at least one rule, the at least one rule comprising at least one of a user rule or an entity rule (e.g., a filtering rule that excludes or allows the user access to supplemental resources based on the user and/or the entities). As used herein, a user rule is a rule that determines the users 4 that can access or that are excluded from the supplemental resources (e.g., allows or excludes some users from receiving and/or using the supplemental resources). In some embodiments, the at least one user rule may comprise an affinity rule. Therefore, if the user 4 and interaction entity already have an existing relationship (e.g., for providing and/or using supplemental resources), these users may be allowed or excluded from receiving the supplemental resources through the resource entity. The affinity rule comprises at least one of a full affinity rule or a partial affinity rule. When the affinity rule comprises a full affinity rule, the user is completely allowed or excluded from receiving supplemental resources if the interaction entity already has an existing relationship with the user 4. When the affinity rule comprises a partial affinity rule, the user 4 is allowed to or excluded from receiving supplemental resources associated with a particular product, category of products, an entity, industry, or the like associated with a particular interaction entity that already has an existing relationship with the user 4 for the particular product, category of products, entity, industry, or the like; however, the user 4 may receive supplemental resources associated with other products, categories of products, entities, industries, or the like associated with the particular entity. Additionally or alternatively, the user 4 may be allowed to or excluded from receiving supplemental resources associated with a competitor of a particular interaction entity if that particular interaction entity already has an existing relationship with the user 4.

In some embodiments, an entity rule is a rule that allows or excludes some interaction entities from providing supplemental resources to users 4 associated with an interaction entity. In some embodiments, the at least one entity rule comprises a category code rule. Therefore, an interaction entity associated with a predetermined category code (e.g., a healthcare code, or the like) is allowed to or excluded from providing supplemental resources. However, the resource entity managing the resource pool of the user 4 may set up a list of interaction entities that trigger exceptions. Interaction entities that trigger exceptions can provide supplemental resources even if these entities are associated with the excluded category codes.

It should be understood that specific user rules and/or entity rules have been described herein; however, any user rules or entity rules may be utilized to determine what users 4 have access to supplemental resources.

At block 220, the method comprises receiving user information associated with a user 4, the user information may comprise resource pool information associated with the user's resource pool. In some embodiments, resource pool information, as used herein, refers to information associated with the user's resource pool managed by one or more resource entities. In some embodiments, the resource pool information comprises an interaction history (e.g., a transaction history, or the like) associated with the user's resource pool. The interaction history includes the types of interactions, frequency of interactions, resources used for the interactions, entities involved in the interactions, resource balance history, or the like. As used herein, an interaction, may be a transaction such as a purchase, a deposit, a withdrawal, a credit, a debit, or the like associated with a resource pool.

In some embodiments, the user information comprises other information as well. For example, in some embodiments, the user information comprises personal information (e.g., demographic information, salary information, contact information (mailing address, email address, phone number, or the like), residence address history, education information, job profile information, or the like) associated with the user 4. In some embodiments, the personal information further comprises social network information associated with the user's social network account or other non-account related information associated with the user. In some embodiments, the user information further comprises user information (e.g., personal information, account information, or the like) associated with the user's immediate or extended family members or contacts (e.g., as determined from social network information). In some embodiments the social networking information may be captured by the resource entity systems 10 (or entity acting on its behalf) by accessing public social networking accounts of the user 4 or by accessing the user's private social networking account (e.g., by the user providing the resource entity system 10 the user's login and password or otherwise becoming a content of the resource entity system).

At block 230, the method comprises determining whether to allow a user 4 access to supplemental resources based on the at least one rule and/or based on the received user information. It should be understood that the resource entity may have agreements with interaction entities for providing supplemental resources to the user 4 if the user 4 enters into interactions with the interaction entities. The supplemental resources enable the user 4 to apply the supplemental resources to an interaction with an interaction entity in order to reduce the resources the user 4 uses from the user's resource pool to complete the interaction. As such, using the at least one rule and the received user information, the resource entity determines the targeted supplemental resources to present to the user 4. By using targeted supplemental resources, the resource entity can identify the users 4 most likely to use the supplemental resources in order to keep the users from leaving the resource entity applications 17 and keep the user's using the resources of the resource entity for the interactions with the interaction entities, and also reduces the storage capacity and processing capacity required to present the supplemental resources to the users 4 (e.g., because the supplemental resources are targeted to specific users 4 and not sent out randomly).

At block 240 in FIG. 2, when a user 4 qualifies for supplemental resources the resource entity may provide a notification to a user 4 regarding the supplemental resources. It should be understood that the user may receive a notification regarding the targeted supplemental resources from the resource entity. For example, the notification of the supplemental resources may be presented to the user 4 through the resource entity application 17 (e.g., user's online account accessed through the user computer systems 20), the social networking account of the user 4, electronic communication with the user 4 (e.g., user's e-mail, text message, sms message, other messaging channel, or the like), or the like, as will be described in further detail later.

As illustrated by block 250, regardless of how the supplemental resources are presented, an indication of an action is received regarding the one or more supplemental resources accepted by or for the user 4. The user 4 may take an action by accepting one or more of the supplemental resources presented to the user 4. In other embodiments of the invention, one or more of the plurality of supplemental resources may be added automatically based on the one or more supplemental resources determined for the user 4 as previously discussed with respect to block 230 (e.g., all of the supplemental resources for the user 4 are automatically added, or the like).

At block 260 an indication is received that a user 4 has entered into an interaction with an interaction entity using the user's resources from the resource pool of the user 4 at the resource entity. The indication may include the product associated with the interaction, the amount of the interaction, and/or the resource pool used by the user 4 to enter into the interaction. Should the interaction be allowed (e.g., there are no interaction limits on the user preventing the interaction, the interaction entity is allowed, the user's resource pool can cover the balance, or the like) resources from the user's resource pool are allocated for the interaction.

At block 270, as will be described, in some embodiments, the supplemental resources may be applied at a point of time in the future when the interaction that qualifies for the supplemental resources is processed.

In some embodiments, when an interaction is processed by the resource entity at a time in the future (e.g., at settlement time or processing time after the interaction is entered), the system determines whether the supplemental resources are still active and whether the supplemental resources are still valid with respect to both the user 4 and the interaction entity interacting with the user 4. This post-transaction process may be referred to as a supplemental resource reconciliation process. The supplemental resources are still active if the supplemental resources have not been revoked by at least one of the resource entity or the interaction entity, and/or if the supplemental resources have not expired.

The supplemental resources are valid with respect to the interaction entity if the interaction entity is not excluded under any entity rules. In some embodiments, in order for the supplemental resources to be valid, the interaction entity cannot be excluded under any entity rules that were in force at the time of the interaction. Additionally or alternatively, in some embodiments, in order for the supplemental resources to remain valid, the interaction entity cannot be excluded under any entity rules that are in force at the time of settlement of the interaction. Therefore, in some embodiments, the interaction entity cannot be excluded under any new entity rules that have been introduced since the interaction.

The supplemental interactions are valid for the user 4 if the user 4 is not excluded under any user rules. In some embodiments, in order for the supplemental resources to be valid, the user 4 cannot be excluded under any user rules that were in force at the time of the interaction. Additionally or alternatively, in some embodiments, in order for the supplemental resources to remain valid, the user cannot be excluded under any user rules that are in force at the time of settlement of the interaction. Therefore, in some embodiments, the user cannot be excluded under any new user rules that have been introduced since the purchase transaction.

In still other embodiments of the invention, the supplemental resources may also meet specific interaction rules (e.g., transaction rules) regarding the interaction of the user with the interaction entity. The interaction rules may be set by the interaction entity and/or the resource entity. For example, the interaction rules may require the user 4 to enter the interaction at a specific date, time of day, location, interaction channel (e.g., in person, over the Internet, over a telephone, or the like), for a specific amount of resources, or the like. Moreover, the interaction rules may require the user 4 to use resources from specific resource pools.

If the user rules, interaction entity rules, and/or the interaction rules are met at the time of the interaction and/or time of settlement, the supplemental resources are still valid and the resource entity applies the supplemental resource amount to the user's resource pool and/or reduces the resource amount provided to the interaction entity by the supplemental resources. In some embodiments, if at least one of the user rules, interaction entity rules, and/or the interaction rules are not met at the time of the interaction and/or settlement, the supplemental resources are invalid and the resource entity does not apply the supplemental resource amount to the user's resource pool and/or applies the full resource amount to the interaction entity. In alternate embodiments, even if at least one of the user rules, interaction entity rules, and/or interaction rules are not met at the time of settlement, the supplemental resources remain valid as long as the all of the rules were met at the time of the interaction, and consequently the resource entity applies the supplemental resource amount to the user's resource pool and reduces the resource amount provided to the interaction entity by the supplemental resource amount.

In some embodiments, the supplemental resources (e.g., a notification of the access to the supplemental resources) are presented via at least one of a targeted integrated interface associated with the user's resource pool (e.g., online banking account, mobile banking account on a portable mobile communication device, or the like), via a targeted integrated interface associated with the user's social network account, or the like. In some embodiments, a notification of the supplemental resources is presented adjacent to, such as inserted into or presented alongside (e.g., on the right, left, top, bottom side of an electronic interfaces related to an interaction with an interaction entity), the interaction history that is presented on the user's online resource pool interaction interface (e.g., online interaction account interface).

Therefore, for example, if ten interactions are listed in the interaction history list, the notification of the supplemental resources may be presented between the fourth and fifth interactions on the list. In some embodiments, the notification of the supplemental resources may be related to the transaction which the offer is presented alongside (e.g., the fourth and/or fifth transaction in the above example). For example, if the fourth interaction is a transaction for product ‘A’ from interaction entity ‘A,’ the supplemental resources are for a transaction for product ‘A’ (e.g., from any interaction entity) or for a transaction from interaction entity ‘A’ (e.g., for any product) or for a transaction of product ‘A’ from interaction entity ‘A.’ Alternatively, the supplemental resources may be for a transaction of a substitute product ‘A’ (e.g., from interaction entity ‘A’ or from any other interaction entity).

In other embodiments of the invention, the supplemental resources may be provided as an alert within the resource entity application 17 (e.g., online interaction account), which when selected may provide a targeted integrated interface with a plurality of supplemental resources for which the user 4 qualifies. In some embodiments, the notification for the supplemental resources is transmitted to the user's email account. In other embodiments, the notification for the supplemental resources is transmitted, via text message or the like, to the user's mobile device.

In some embodiments, the presented supplemental resources are related to at least one of an interaction previously entered by the user (e.g., a previous transaction associated with the user's financial institution account), an interaction from an interaction entity from which the user previously entered into an interaction, an alternative to the interaction previously entered into by the user, or an alternative to the interaction from the interaction entity from which the user previously entered into an interaction. The alternative to the interaction may be determined based on interaction histories associated with a plurality of resource pools associated with multiple users. In some embodiments, the presented notification for the supplemental resources relates to a new product related to a previous product interaction made by the user. For example, if the user previously bought a stove, the supplemental resources may be related to a dishwasher or a stove maintenance service.

In some embodiments, a notification of supplemental resources sent to or presented on a resource pool associated with a first member of a family may be used by a second member of the family. In some embodiments, the second member of the family may use the supplemental resources even if the second member is not associated with the resource pool associated with the first member. For example, the supplemental resources associated with a particular interaction entity may be transmitted to (or linked to) a resource pool associated with a first family member. When the second member of the family enters an interaction that qualifies for the supplemental resources using the second member's resource pool (e.g., any qualifying payment method), the second member receives the allocation of the supplemental resources after entering into the interaction. The resource entity may have access to information that indicates that the second member is a family member of the first member even if the second member is not listed as being associated with the resource pool associated with the first member.

Additionally, in some embodiments, as part of the previously described supplemental resources reconciliation process at the time of settlement of the supplemental resources, the system determines whether the resource pool information substantially matches the supplemental resources information. If the resource pool information has changed since the interaction such that the resource pool information no longer substantially matches the supplemental resources information, the supplemental resources may be deemed to be invalid and the resource entity does not provide allocation of the supplemental resource amount to the user's resource pool. However, in other embodiments, even if the resource pool information has changed since the interaction, the offer remains valid and the financial institution provides a rebate to the user's financial institution account.

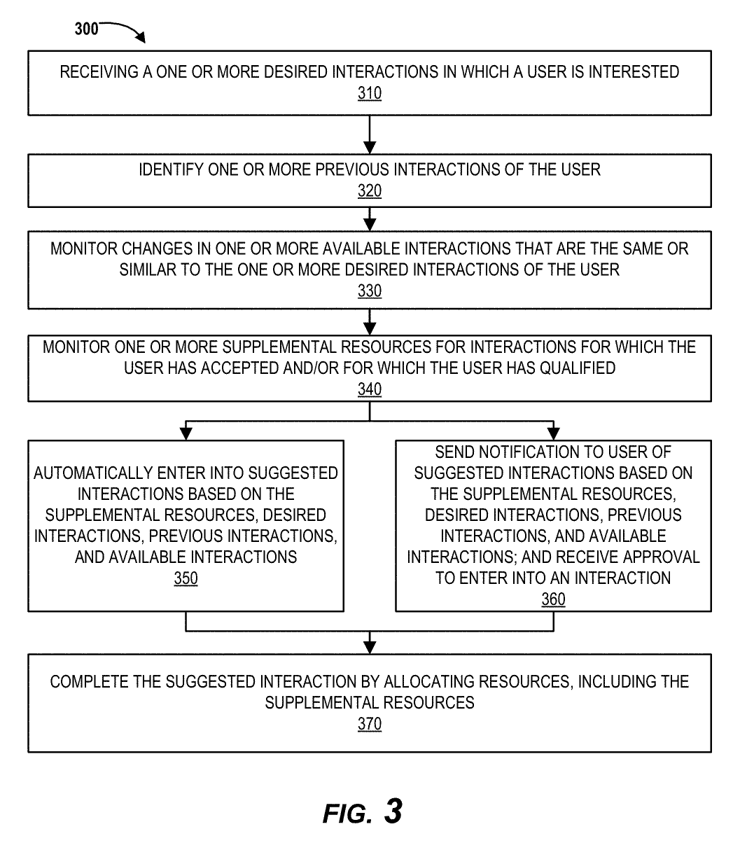

FIG. 3 illustrates a process flow for determining interactions for a user based in part on desired interactions and supplemental resources. In some embodiments of the invention the interactions may be proactively entered based on anticipated need from reviewing previous interactions, as well as from a desired list of interactions, the resource amounts associated with desired interactions and/or previous interactions that are currently available, and/or the supplemental resources for which the user 4 has qualified (e.g., qualified and selected, or qualified but not yet accepted).

FIG. 3 illustrates in block 310 that one or more desired interactions in which a user 4 is interested is received. In one example, the user indicates the one or more interactions (e.g., transactions for products) to a list (e.g., a transaction cart, wish list, or the like) to indicate the products in which the user 4 is interested. In one embodiment, the user 4 may select the interactions through the user application 27 on the user computer system 20 while connected to a resource entity application 17 through the resource entity systems 10, or through the interaction entity systems 30 and/or third-party entity systems 40. In some embodiment the selection of the interaction may be based on products that the user 4 is presented by the resource entity through the use of an integrated interface. The integrated interface may be a list of previous interactions of the user 4 that includes the references to available interactions and/or supplemental resources associated with available interactions for which the user 4 has qualified. The integrated interface may further be an interface of interactions based on all the supplemental resources for which the user 4 has qualified, and thus the user 4 may select the one or more supplemental resources that the user 4 would like to accept in order to indicate an interaction in which the user 4 is interested. Alternatively, the integrated interface my include a social networking interface, search results interface, or other like Internet browser or dedicated application interface, any of which may be used to receive an indication from a user 4 that the user is interested in a particular interaction and/or supplement resources for an interaction.

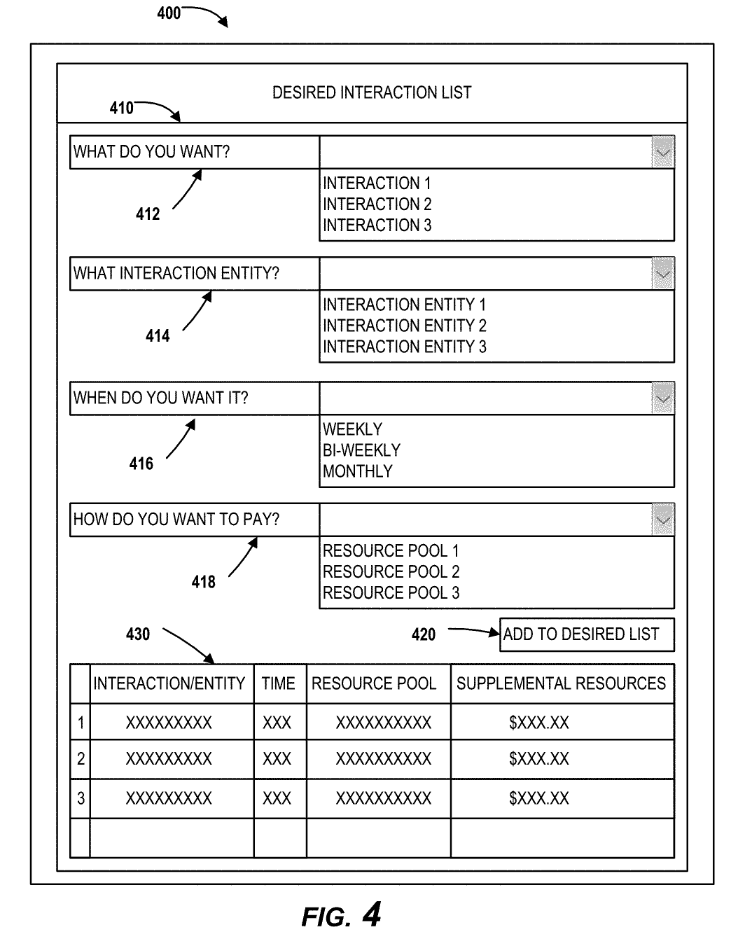

One example of a desired interaction integrated interface 400 may include a desired interaction list, such as a shopping list, wish list, or the like, as illustrated in FIG. 4. As illustrated in FIG. 4, the desired interaction list interface 400 may include a desired interaction selection section 410 and a desired interaction list section 430. The desired interaction selection section 410 may include an interaction selection 412 (e.g., a product or transaction selection), which allows a user to select a particular interaction in which the user 4 may be interested. The desired interaction selection section 410 may also include an interaction entity selection 414 (e.g., a merchant selection), which allows a user 4 to select an interaction entity with which the user 4 would like to enter into an interaction. The desired interaction selection section 410 may further include an interaction time period selection (e.g., a recurring interaction period), which allows the user 4 to indicate how frequently the desired interaction should occur. The desired interaction selection section 410 may further include an interaction resource pool section (e.g., a user account selection), which allows the user 4 to select the resource pool that should be used for the interaction. It should be understood that the desired interaction selection section 410 may include other selections that have been described herein, but not specifically illustrated in the example in FIG. 4. Moreover, it should be understood that the user 4 may leave one or more of the selections blank or may select all (e.g. all resource pools, all interaction entities, or the like) and in response the resource entity may search for all selections that are relevant (e.g., search all interaction entities). The desired interaction selection section 410 may further include an “add to” desired list selection feature 420 (e.g., button, or the like) that adds the interaction to the user's desired interaction list.

The desired interaction integration interface 400 may further include a desired interaction list section 430 that provides the list of the interactions in which the user 4 is interested. As illustrated in FIG. 4, the desired interaction list may include the interaction entity, the time period for which the interactions should be entered, and the resource pool(s) that should be used for the interaction. In some embodiments the desired interaction list may be embedded with an indication of the supplemental resources (e.g., offer, offer amount, or the like) for which the user has qualified and/or accepted in order to illustrate the available supplemental resource associated with a particular interaction. The user 4 may be able to accept supplemental resources that are made available to the user 4 in the desired interaction list section 430 of the interface 400 (e.g., integrated interface). The user 4 may also be able to add, edit, or delete interactions in the interface 400. As is described throughout herein, the desired interactions (e.g., the desired interactions included in the desired interaction integrated interface 400) may be used by the resource entity in order to identify suggested interactions for the user 4.

Block 320 of FIG. 3 illustrates that the previous interactions of the user 4 are identified. As described herein, in some embodiments the previous interactions may be transactions for products that the user 4 has made in the past. The identification of the previous interactions may include identifying the previous interaction information. The previous interaction information may include the timing of the previous interactions, such as but not limited to periodic timing (e.g., the time of year, month, day, or the like), frequency timing (e.g., how many times during the periodic timing), the quantity timing (e.g., quantity as it relates to the periodic timing), or other like timing information. The timing of the previous interactions may include timing thresholds. The timing thresholds may proactively provide indications to the resource entity when the user 4 may need to enter into interactions. For example, if a user typically enters into an interaction twice a month, and a month has almost passed with the user only having entered into one interaction, it may indicate that the user 4 may like to enter another interaction before the month is over. The previous interaction information for the previous interactions may be one factor used in determining suggested interactions for the user 4.

It should be understood that the previous interactions and associated previous interaction information may be captured from a number of sources, for example, but not limited to the resource entity through which the supplemental resources are provided to the user, other resource entities (e.g., other institutions through which the user 4 has access to resources), interaction entities (e.g., the interaction entities though which the users enter into interactions), other third-party entities (e.g., budgeting aggregators, or other entities that collect interaction information for the user in a central location). The previous interactions may be captured by the resource entity system 10 communicating with the user computer systems 20, the interaction entity systems 30, and/or the third-party 40.

FIG. 3 further illustrates in block 330 that changes in available interactions that are the same as or similar to the desired interactions of the user 4 are monitored. For example, the resource entity 10 alone, or based on information provided by the interaction entity systems 30 or third-party entity systems 40, may monitor changes in the resource amount of the interactions (e.g., costs of products in the transaction) that are the same as or similar to the desired interactions that the user added to the user's desired list. The interactions that are the same as or similar to the desired interactions on the user's desired list may include transactions for the same products with the same entity as included on the user's desired list, transactions for products that perform the same function, or transactions for the products that are the same as the products on the user's desired list but are provided by a different entity. For example, the resource entity systems 10 may monitor the changes in the resource amount (e.g., prices) of the same or similar products that are on the user's desired list in order to determine when the interaction reaches an acceptable amount, such as when the amount hits a threshold. As such, in some embodiments, the resource amount for particular interactions may be monitored across multiple interaction entities (e.g., amount comparison) until the resource amount from at least one of the interaction entities reaches a resource amount threshold that indicates a point at which the user 4 may be interested in entering the interaction. The resource amount threshold may be based on input provided by the user 4 (e.g., a user defined resource threshold threshold), or may be based on a determination made by analyzing the user's previous transactions (e.g., enter the interaction when the resource amount for the interaction meets the resource amount of the previous interaction). Alternatively, the resource entity system 10 may monitor when a particular interaction becomes available (e.g., goes on the market, is available in a particular region, meets a quantity requirement, or the like). It should be understood that the resource entity systems 10 may do the monitoring, a third-party may do the monitoring for the resource entity, or an interaction entity may send the information to the resource entity when an interaction reaches a certain resource amount, availability, or the like.

Block 340 of FIG. 3 indicates that the supplemental resources for interactions which the user has qualified (e.g., accepted and/or for which the user has been provided but not yet accepted) are monitored. In one embodiment the resource entity systems 10 may compare the supplemental resources for which the user has qualified with the user's desired interactions, previous interactions, and/or available interactions. In some embodiments, the user's desired interaction list and an accepted supplemental resources list may be a single integrated interface. For example, the integrated interface may include both an indication of the user's desired interactions that the user has added to a desired interaction list, as well as the supplemental resources available for the desired interaction list. As such, the desired interaction list may include an integrated interface of both the user's desired interactions as well as the supplemental resources for which the user has qualified. In other embodiments of the invention, the resource entity may take the desired interaction list and compare the list of desired interactions with all available supplemental resources for which the user 4 has qualified (e.g., regardless of whether or not the user has accepted the supplemental resources). Moreover, in some embodiments the resource entity may take the desired interaction list and compare the list to the user's previous interactions. It should be understood, that the resource entity systems 10 may do the monitoring, a third-party may do the monitoring for the resource entity, or an interaction entity may send the supplemental resource information to the resource entity when the supplemental resources become available and/or when the user 4 qualifies for the supplemental resources. As such, the available supplemental resources for which the user has qualified may be another factor in determining the suggested interactions for the user 4.

FIG. 3 illustrates in block 350 that the resource entity system (or the third-party on behalf of the resource entity system) may automatically enter into interactions based on the desired interaction list of the user 4, the previous interactions of the user 4, the monitoring of the changes in the available interactions that are the same as or similar to the desired interactions or previous interactions of the user 4, and/or the monitoring of the supplemental resources for which the user 4 has qualified. For example, when the resource entity system identifies a transaction for a product that is listed on the user's desired interaction list, the product meets timing thresholds (e.g., the past transaction occurred outside of, or near the end of, a time period in which the user has indicated more of the product is needed), the amount of the transaction for product meets an amount threshold (or other threshold is met), and/or the user qualifies for supplemental resources, the system may automatically enter into the interaction. In some embodiments, the threshold for the transaction amount may be independent of the supplemental resource amount available or may be in addition to the supplemental resource amount. As such, there may be a set amount for the transaction in which the user 4 is interested, and the set transaction amount may be based solely on the amount of the product, solely based on the supplemental resource amount, or based on the combination of the resource amount after incorporating the supplemental resource amount.

In some embodiments of the invention, in order to automatically enter into interactions on behalf of the user 4, the user may provide permission for the resource entity system to enter into interactions. For example, the user 4 may indicate that the resource entity may enter into all interactions for the user 4, all interactions on the user's desired interaction list, or specific interactions selected by the user 4 on the user's desired interaction list. As such, in some embodiments, the user 4 may provide pre-approval for the resource entity to enter into specific interactions on the user's desired interaction list, and may also place pre-approval limits on the automatic interactions, for example, threshold limits for interaction resource amounts, interaction quantities, interaction time periods, interaction entities, interaction location, and/or the like.

In other embodiments of the invention, as illustrated by block 360 in FIG. 3, after a determination is made of suggested interactions, instead of automatically entering into the interaction, a notification is sent to the user 4 for approval to enter into the interaction. In response, user approval may be received from the user 4 to enter into the interaction. The notification may be presented to the user 4 through a number of different channels. In some embodiments, the notification is sent to the user 4 through one or more integrated interfaces, such as the one or more integrated interfaces described herein (e.g., the integrated interfaces on the resource entity application 17 that the user is accessing through the user application 27). In other embodiments of the invention, the notification is presented to the user through e-mail, text message, or other like communication channel.

In some embodiments the interaction may be scheduled for automatic entry, but a notification may also be sent to the user 4, not for approval to enter into the interaction, but to notify the user 4 that an interaction is about to occur (e.g., pending interaction). In response, the user 4 may be able to respond to the pending interaction notification in order add additional interactions (e.g., transactions for additional products) to the current pending interactions. In other embodiments, the user 4 may be able to move up, move back, or delete the interaction that is about to occur in response to the pending interaction notification.

As illustrated by block 370 in FIG. 3, regardless if the interaction is entered into automatically or through user notification and acceptance, the interaction is completed as previously discussed with respect to FIG. 2. As previously discussed, in one embodiment of the invention, the interaction occurs between the user 4 and the interaction entity systems 30 using resources of the user 4 through the resource entity system 10 without taking into account the supplemental resources for which the user has qualified. Thereafter, at a later point in the time, such as during settlement, the supplemental resources are applied to the user's resource pool (e.g., account) and the resource entity provides the resource amount for the interaction to the interaction entity after deducting the supplemental resource amount from the resource amount. In alternative embodiments of the invention, the resource entity may settle the interaction by applying the supplemental resource amount to the user's account and/or to the resource amount for the interaction and applying the full amount of the resources to the interaction entity. Thereafter, at a later point in time the resource entity may bundle of all of the supplemental resources for multiple interactions from multiple users 4 with the interaction entity into a single request for a time period (e.g., all interactions that occur during a day, week, month, or the like) and request that the interaction entity provides the bundled supplemental resource amount to the resource entity for the time period at one time.

It should be further understood that in some embodiments of the invention, since the resource entity interaction is scheduling the user's interactions in advance, the resource entity may interact directly with the interaction entity and bypass the traditional channels for processing of interactions (e.g., payment processing channels with a clearinghouse, resource pool intermediary, such as a card issuer, or the like). During typical transaction processing the resource entity and/or the interaction entity are not aware that an interaction is about to take place, as such, when the user 4 enters into an interaction, the interaction is run through third party verification to determine if the user 4, the interaction entity, and/or the resource entity are all the proper parties for the interaction, that the resources are available and the interaction is acceptable. Alternatively, because the interaction of the present invention is scheduled through the resource entity all the information is already known before the interaction actually occurs and the interaction is routed directly between the resource entity and the interaction entity. As such, the resource entity may contact the interaction entity directly before entering into the interaction to indicate that the scheduled interaction is a trusted interaction that does not have to be verified through an interchange, or the like. The resource entity may enter the interaction on behalf of the user 4 and indicate to the interaction entity that the resources (with or without the supplemental resources being applied to the interaction) will be provided to the interaction entity on a particular day and/or time in exchange for the product provided by the interaction entity. Moreover, it should be understood that because the interaction does not have to be processed through a third-party, the resource entity and/or the interaction entity do not have to pay for the third-party processing (e.g., no interchange costs). As such, the entire amount saved on processing, or a portion thereof, may be passed on to the user 4, and/or kept by the resource entity and/or the interaction entity. Additionally, in some embodiments, because the interaction is scheduled, instead of the supplemental resource amount being applied after the interaction at settlement (e.g., rebate), the supplemental resource amount may be applied at the time of the interaction (e.g., discount).

Additionally, it should be understood that in some embodiments of the invention, the amount saved by the user 4, the supplemental resources, and/or additional supplemental resources that may be provided by the resource entity and/or the interaction entity for entering the transaction (e.g., additional discounts, rewards, or the like from the resource entity, and/or additional discounts, rewards, or the like from the interaction entity, in some cases due to the reduction of the interchange fees) may be applied to the present interaction and/or a portion may be deferred to additional scheduled interactions in the future.

Referring generally to the embodiments of the invention, supplement resources may be offers for discounts, rebates, and/or coupons (e.g., reverse couponing) that are applied to the user's resource pool retroactively after the interaction has been made. As such, the system enables transmission of individualized or personalized offers to users. For example, an offer associated with a merchant may be a 10% discount on a purchase made from that merchant. As an example, the activated offer may be a rebate of $5 on a purchase of $20 from a department store. The user may decide to use the offer by visiting the department store and making a purchase of $20. In some embodiments, at the point of sale, the user pays $20 for the user's purchase using an eligible payment method determined by the financial institution or the merchant (e.g., payment card, mobile device payment, check, or the like). When the transaction is processed by the financial institution at a predetermined settlement time in the future (e.g., as part of a periodic batch processing operation to generate monthly account statements), the financial institution provides a rebate of $5 to the user's financial institution account. Therefore, the department store, at the point of sale, may have no knowledge that the user will receive a rebate at some point in the future. In some embodiments, even the user may not be aware of the rebate at the point of sale (e.g., if the offer was automatically activated). In other embodiments, the point of sale terminal may provide an indication to at least one of the department store or the user that the user will receive a rebate at some point in the future.

In one example of the invention discussed herein, the user 4 may add products to the user's list of desired products. The list of desired products may include user's desired timing of the desired products (e.g., when the user would like to enter into interactions for the products), desired quantity of desired products (e.g., the user may only desire to enter into the interaction if there are a specific quantity of the products), desired one or more merchants with which the user would like to transact for the products (e.g., specific interaction entities with which the user would like to interact), desired location from which the products are received (e.g., regions within a state, group of states, countries, or the like from which the user would like to receive the products), or other desired requirements for the desired interactions for the desired products. The resource entity then identifies the user's previous interactions to determine past products for which the user 4 has entered into transactions. For example, the resource entity may identify products that the user purchases every month (or in a different time period), and identify that the user has yet to purchase the products in the current month (or other time period) or the user has yet to purchase the same quantity in the current month. The combination of the products on the user's desired list and the user's previous interaction history may result in the resource entity automatically purchasing the products for the user, as previously discussed herein. The resource entity may also monitor changes in available products, such as by monitoring the availability of products, the resource amount for the products, or the like. The combination of the monitoring the available products with the products on the user's desired interaction list and/or the user's previous transactions for products may result in the resource entity automatically entering a transaction for the products for the user 4, or sending a notification to a user to allow the resource entity to enter a transaction for the products for the user 4. As such, when the products from the user's desired products reach a threshold resource amount in the market, the resource entity may enter a transaction for the products. The resource entity also monitories the supplemental resources for products from various interaction entities. For example, the resource entity will determine what supplemental resources are available (e.g., the user has already accepted or for which the user has qualified but not yet accepted) to the user 4 or to apply to an interaction on behalf of the user 4 in order to automatically enter into an interaction for a product for the user 4 (or otherwise send a notification of the interaction to the user 4). The combination of monitoring the supplemental resources available to the user 4 for products in combination with the products on the user's desired interaction list, the previous products for which the user transacted, and/or available products from the interaction entities may result in the resource entity automatically entering an interaction for the products for the user 4, or sending an notification to a user 4. For example, when the combination of the resource amount of available products on the market in combination with the supplement resources (e.g., offer) for which the user qualifies meets a threshold resource amount for a product that the user has included on the user's desired products list, and the user's previous transactions for the product are not satisfied, the resource entity institution will automatically enter into the transaction for the product.

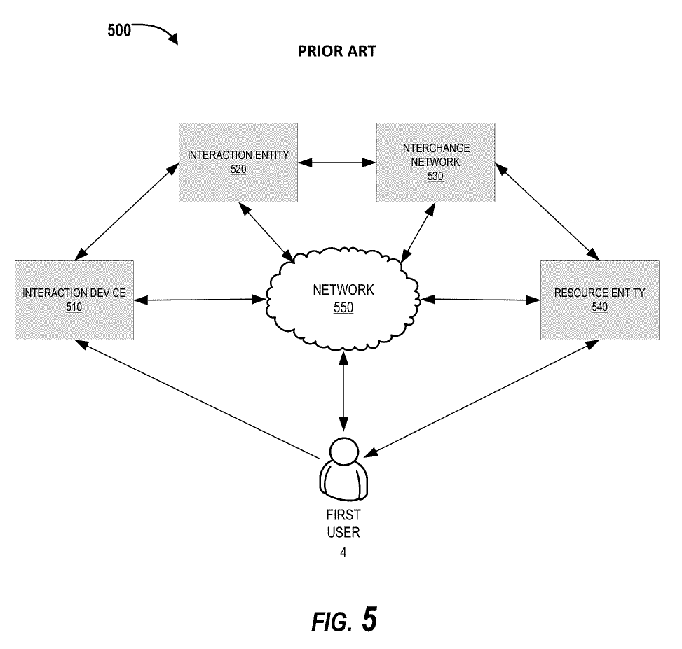

Referring now to FIG. 5, a block diagram 500 illustrates a prior art system for processing and finalizing interactions. Typically, finalizing an interaction initiated by a user involves multiple steps and takes two to three days. As illustrated in FIG. 5, first user 4 and user device associated with the first user 4, interaction device 510, interaction entity 520, interchange network 530, and resource entity 540 are operatively coupled via a network 550. The first user 4 initiates an interaction, via an interaction device, at an interaction entity location. Once the interaction is initiated, the interaction device transfers information associated with the interaction to the interaction entity. The interaction device may be any sales interface (e.g., in person at a point of sale, through the Internet, or the like) used for performing transactions with a merchant. The interaction entity may be any merchant offering services and products to the user or an acquiring entity associated with the merchant. For example, once the user initiates a transaction at the interaction device using a credit card or a debit card, the interaction device transfers the credit card or debit card information such as number, CVV, expiration date, and/or the like to the interaction entity 520. After receiving the information associated with the interaction, the interaction entity 520 sends a request to the interchange network 530 to authorize the interaction. The interchange network 530 may be any third party entity facilitating communication between the interaction entity 520 and the resource entity 540. The interchange networks may include one or more third party entities such as routing networks, acquiring processors, credit card or debit card networks. The interchange network 530 after receiving the request, clears the interaction and requests authorization of the interaction from the resource entity 540. The resource entity 540 may be any issuing bank associated with resource pool of the user. The resource entity 540, approves or declines the interaction and sends back appropriate response to the interchange network 530, which sends the appropriate response to interaction entity 520. Once, the interaction entity 520 receives the authorization, the resource entity will place a hold on an amount associated with the interaction in the account of the user. The interaction entity 520 upon receiving authorization, approves the interaction at the interaction device. At the end of the day, the interaction entity 520 sends approved authorizations in a batch to the interchange network 530 and upon receiving the approved authorizations, the interchange network 530 forwards each approved interaction to the appropriate resource entity 540. The resource entity 540 transfers the amount associated with the interaction to the interaction entity within two or three days. There exists an interchange cost and a management cost which the interaction entity 520 and the resource entity 540 pay to the interchange network 530. In contrast to the prior art systems, the present invention presents a novel way of processing and completing interactions.

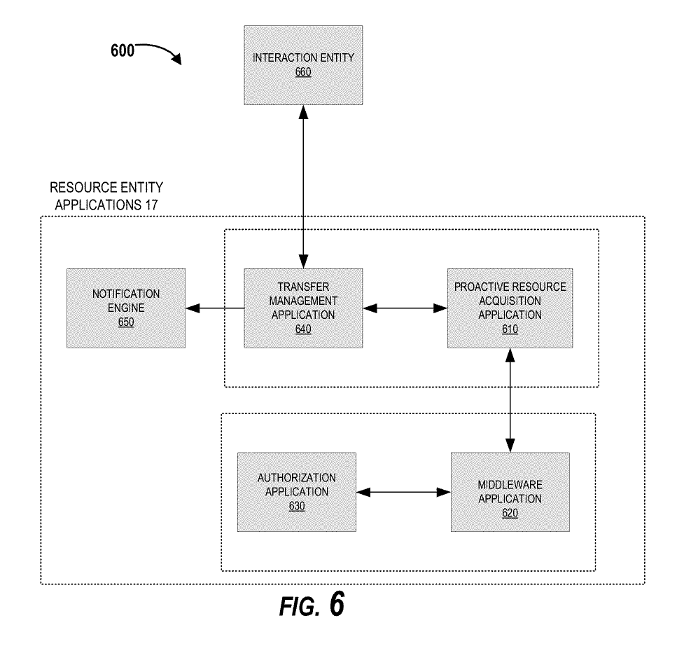

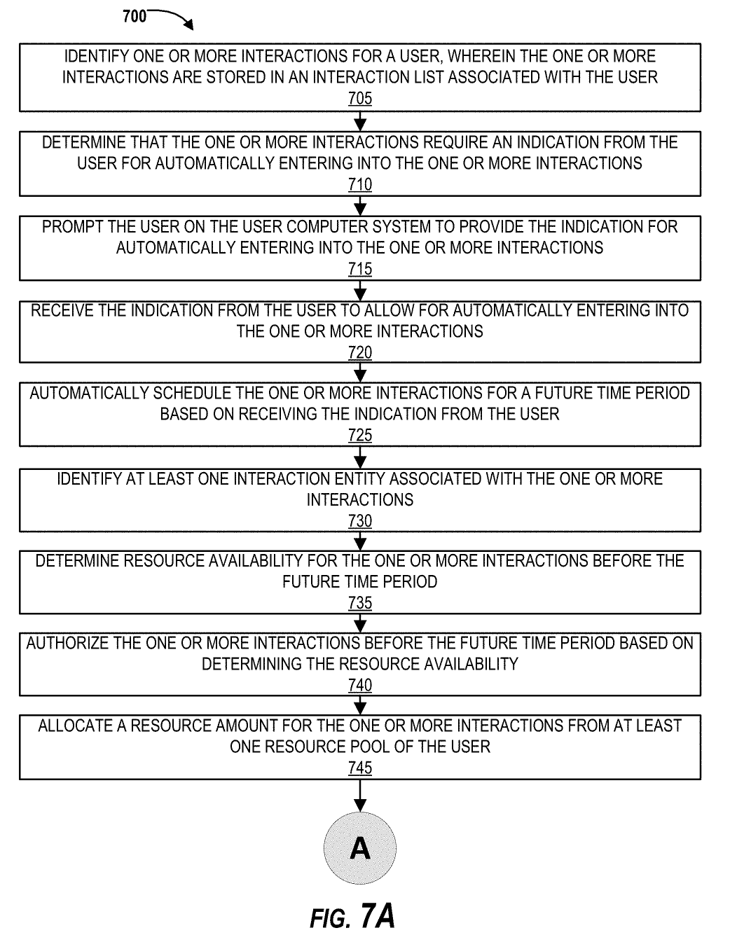

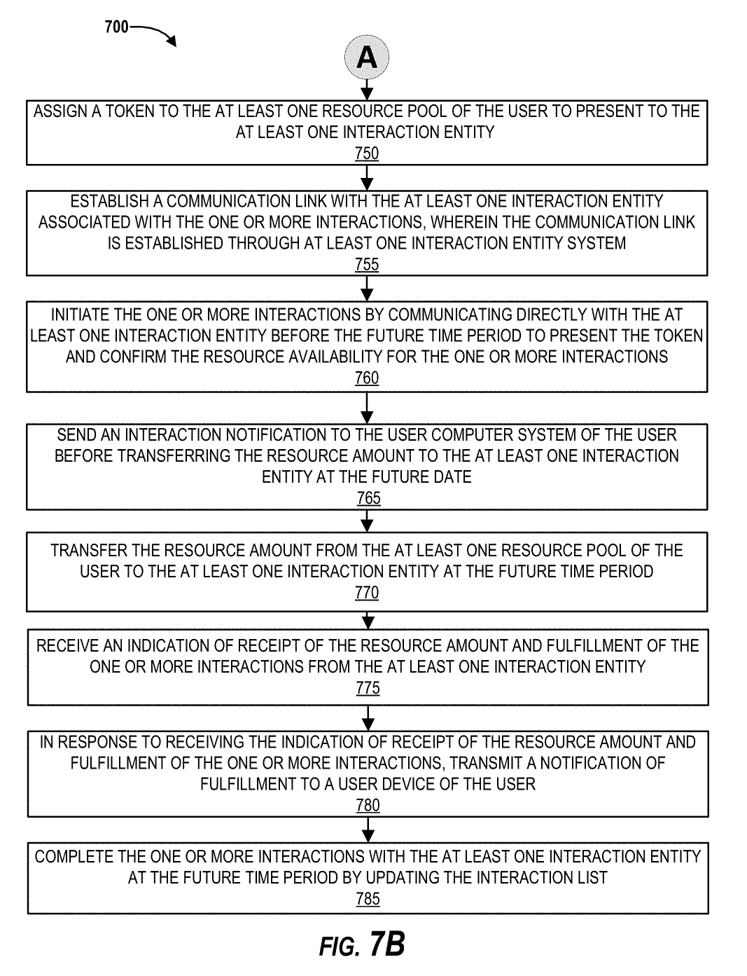

Referring to FIG. 6, a block diagram 600 illustrates one or more applications of the resource entity systems 10, performing the process for facilitating proactive resource acquisition illustrated in FIG. 7A and FIG. 7B, in accordance with embodiments of the present invention. As shown in FIG. 6, the block diagram 600 includes a proactive resource acquisition application 610, a middleware application 620, authorization application 630, transfer management application 640, and notification engine 650 to communicate with an interaction entity 660 for facilitating proactive resource acquisition. In embodiments of the present invention, the proactive resource acquisition application 610, the middleware application 620, the authorization application 630, the transfer management application 640, and the notification engine 650 may be a part of the resource entity applications 17, stored in one or more memory components 16 of the one or more resource entity systems 10. The proactive resource acquisition application 610 identifies one or more interactions scheduled for a future time period. The one or more interactions may be the one or more desired interactions or one or more suggested interactions. The one or more suggested interactions may be identified using the process discussed in FIG. 3. The one or more desired interactions may be any interactions received as an input from the user computer systems 20. Upon identifying the one or more interactions, the proactive resource acquisition application 610 requests the middleware application 620 to authorize the one or more interactions. The middleware application 620 communicates with the authorization application 630 to verify the availability of resources in the user's resource pool. For example, the authorization application verifies if the debit card of the user has enough resources (e.g., funds) in the user's resource pool to complete the interaction (e.g., purchase or transaction). In some embodiments, the authorization application 630 may be a third party application provided by third party entity systems. For example, the authorization application 630 may be an application provided by a credit card vendor or a credit card processing entity. In alternate embodiments, the authorization application 630 may be an application owned by the resource entity system 10. For example, the authorization application 630 may be an application provided by the financial institution associated with the credit card of the user.

The authorization application 630 verifies that the user's resource pool has sufficient resources to complete the one or more interactions and sends an approval or a denial notice to the middleware application 620. Upon receiving the approval notice from the authorization application, the middleware application authorizes the one or more interactions and communicates an authorization notice to the proactive resource acquisition application 610. In some embodiments, the process of authorization of the one or more interactions is performed by the proactive resource acquisition application 610 before the future time period at which the one or more interactions are scheduled. In some embodiments, the authorization of the one or more interactions are performed days in advance of the future time period (e.g., one or more days, two or more days, three or more days, or more). In other embodiments, the authorization of the one or more interactions are performed hours before the future time period. In some embodiments, the authorization of the one or more interactions is performed two hours before the future time period. In alternate embodiments, the authorization of the one or more interactions is performed more or less than two hours before the future time period. In some other embodiments, the process of authorization of the one or more interactions is performed at the future time period. For example, the authorization is initiated at a time scheduled for completing the one or more interactions.

Upon receiving the authorization of the one or more interactions, the proactive resource acquisition application 610 initiates the one or more interactions by initiating one or more triggers in the transfer management application 640. The one or more triggers may include sending notifications to the user, establishing communication link with the interaction entity 660, and/or the like. The transfer management application 640, upon activation of one or more triggers, establishes a communication with the interaction entity associated with the one or more transactions and confirms the authorization of the one or more interactions (i.e., availability of resources in the user's resource pool before the future time period). The transfer management application 640 communicates with the interaction entity 660 to determine the one or more available resource interactions. The transfer management application 640 also notifies the user, via the notification engine 650, about the authorization of the one or more interactions before the future time period. Moreover, the transfer management application 640, for example, through the authorization application 630 may put a hold on the resources of the user. At the future time, the transfer management application 640 transfers the resource amount from the user's resource pool to the interaction entity 660 and receives an indication of receipt of the resource amount and fulfillment of the one or more interactions from the interaction entity 660. Upon receiving the indication, the transfer management application 640 may send a notification of fulfillment to the user, wherein the notification of fulfillment notifies the user of the fulfillment of the one or more interactions via the notification engine 650.

The transfer management application 640 stores information associated with the one or more interactions in a repository and transmits the information to an employee of the resource entity system, via the notification engine 650. For example, the transfer management application 640 may transfer the type of products, the resource amount, the completion date and time of the one or more interaction to an analyst of the resource entity system 10. In some embodiments, the notification engine 650 may be divided into two sub-applications, a user notification engine (not shown) and a user event hub (not shown). The user notification engine sends notifications associated with the one or more interactions to the users and the user event hub sends notifications to the employees. The employees described herein may be any employees of the resource entity systems such as an employee in an analytics team, a customer associate, and/or the like. The notification engine 650 sends notifications to the user about the status of the one or more interactions. For example, the notification engine sends an initiated interaction notification to a user computer system of the user when the one or more interactions are scheduled, wherein the initiated interaction notification comprises the scheduled date and time of the one or more interactions. The notification engine sends a pending interaction notification to the user computer system of the user before meeting the future time period, where the pending notification is sent few days prior to the future time period to notify the user of upcoming interactions. The notification engine sends a completed interaction notification to the user computer system of the user before meeting the future time period of the transaction, where the completed interaction notification is sent just before transferring the resource amount to the user and completing the interaction. The block diagram 600 may have additional blocks to store the history of the one or more interactions in an interaction history database, wherein the transfer management application 640 after storing the information in the repository, transfers the same information to an interaction history application. In some embodiments, it should be understood that the transfer management application 640 may be integral with the proactive resource acquisition application, and/or may interact directly with the authorization application 630 without accessing the middleware application 620.

The process performed using the applications in the block diagram 600, avoids the usage of the interchange networks described in FIG. 5. The time of processing and completion of the one or more interactions is greatly reduced as opposed to the prior art, which typically takes two or three days to complete and finalize the one or more interactions. The present invention provides a unique way to process the interactions before the future date of the interaction and complete the one or more interactions while avoiding interchange processing and the costs charged by the interchange networks.

FIG. 7A and FIG. 7B illustrate a process flow 700 for facilitating proactive resource acquisition. The process flow 700 illustrates the processing involved before the step of automatically entering into suggested interactions described in block 350 of FIG. 3. As shown in block 705, the system identifies one or more interactions for a user, wherein the one or more interactions are stored in an interactions list associated with the user. The one or more interactions include one or more desired interactions and one or more suggested interactions. The one or more desired interactions may be received as an input from the user, via the user computing systems. For example, the user may set up one or more bill pays to one or more interaction entities at regular intervals. In one exemplary embodiment, the user adds one or more products to a shopping cart (not shown) integrated into an online banking portal of the user. The shopping cart allows the user to purchase one or more products offered by one or more merchants, via the online banking portal, thereby eliminating the need for the user to access the interaction entity's web page to purchase the one or more products. In one such embodiment, the user may add one or more products to the shopping cart and the system identifies them as the one or more desired interactions. The one or more suggested interactions are based on the one or more desired interactions, one or more available interactions, and plurality of previous interactions. The plurality of previous interactions may be stored in a profile of the user and the interaction history database. The one or more available interactions are determined by the system by communication with the one or more interaction entities. The one or more suggested interactions are determined by the system as illustrated in process flow 300. The interaction list comprises a list of one or more suggested interactions and the one or more desired interactions scheduled for the user. The interaction list comprises information such as date and time, interaction entity identifier, one or more products, resource amount, available supplemental resources, supplemental resource amount, status of the one or more interactions, and/or the like. The interaction list may be updated after performing every step of the process flow 700. For example, the system may update the supplemental resource amount after determining the supplemental resource amount in step 730. However, the resource amount and the interaction entity identifier may be available as soon the system determines the one or more interactions as described in process flow 300.

As shown in block 710, the system determines that the one or more interactions require an indication from the user for automatically entering into the one or more interactions. In some embodiments, the interaction list may indicate whether the one or more transactions require the indication from the user for automatically entering into the one or more interactions. As shown in block 715, the system prompts the user on the user computer system to provide the indication for automatically entering into the one or more transactions. The prompt may be displayed on the graphical user interface of the user computer system. In some embodiments, the prompt may be displayed on the online banking portal of the user only after determining that the user is active. For example, the system determines that the user has accessed the online banking portal and prompts the user to provide the indication. In some embodiments, the system may provide one prompt for each of the one or more interactions. In some embodiments, the system identifies similar interactions and provides one prompt for all the similar interactions. For example, if an interaction is set to happen every week such as ordering of milk or any such products, the system may group all such interactions scheduled for a month and may provide one prompt to the user. Once the user receives the prompt he provides the indication allowing the system to automatically enter into the one or more transactions. As shown in block 720, the system receives the indication from the user to allow for automatically entering into the one or more transactions.

As shown in block 725, the system automatically schedules the one or more interactions for a future time period. In some embodiments, the system may set a trigger which initiates the process of completing the one or more interactions for the future time period. In some embodiments, the system may set a second trigger to initiate the process of authorization of the one or more interactions before the future time period. The system may update the interaction list with the time and date of all triggers associated with the one or more interactions. In some embodiments, when the one or more interactions are the one or more desired interactions, the user may set the future time period. For example, the user may set the date and time of the one or more desired interactions. In alternate embodiments, wherein the one or more interactions are one or more suggested interactions, the system may automatically set the date and time of the one or more suggested interactions based on the previous interaction history.

As shown in block 730, the system identifies at least one interaction entity associated with the one or more interactions. In some embodiments, the system may identify the at least one interaction entity to determine the supplemental resources associated with the scheduled one or more interactions and the user's resource pool. In such an embodiment, the system after determining supplemental resources for the one or more interactions, identifies or calculates the supplemental resource amount associated with the supplemental resources and updates the interaction list with the supplemental resource amount. For example, the system identifies that an interaction associated with an interaction entity has ten percent discount, the system calculates the supplemental resource amount based on the resource amount associated with the interaction.

As shown in block 735, the system determines resource availability for the one or more interactions before the future time period. For example, the system verifies that the resource accounts associated with the user have the resource amount to finish the interaction, via the middleware application 620 and/or authorization application 630. In some embodiments, if the user has more than one resource pool, the system may select one resource pool based on the available resource and/or supplemental resources and then verifies the resource availability for the one or more interactions in that resource pool. For example, the user's resource pool may have one debit account, two credit accounts. The system determines that the debit account has a discount associated with an interaction and an interaction entity and verifies that there are resources (e.g., funds) equal to the resource amount available in the debit account. As shown in block 740, the system authorizes the one or more interactions before the future time period based on determining the resource availability. In some embodiments, upon successful authorization, the system notifies the user about the authorization of one or more interactions. As shown in block 745, the system allocates a resource amount for the one or more interactions from at least one resource pool of the user. For example, the system after verifying that the user's debit account has required amount of resources, it blocks or holds the resources required to complete an interactions, thereby block the use of those resources for other interactions.

As shown in block 750, the system assigns a token to the at least one resource pool (e.g., for a single interaction, or for a multiple interactions over a period of time) of the user to present the at least one interaction entity. The token may be a unique identifier to represent the at least one resource pool of the user. The resource entity system may use this unique identifier to transfer to the interaction entity, wherein the interaction entity may use the unique identifier to update its records which may be used for auditing or for future reference. As shown in block 755, the resource entity system establishes a communication link with the at least one interaction entity associated with the one or more interactions, wherein the communication link is established directly with interaction entity systems. The resource entity system may establish the communication link via the network 2 shown in FIG. 1. As shown in block 760, the system initiates the one or more interactions by communicating directly with the at least one interactions entity before the future time period to present the token and confirm the resource availability for the one or more interactions. For example, the system may communicate with the merchant and may present details about the one or more products, the date and time of the interaction, the token associated with the account of the user, and availability of resources in the account of the user. In some embodiments, this step of communicating with the interaction entity may be performed before the future time period (e.g., hours, days, or the like). In some embodiments, this step may be performed more than twenty four hours before the future time period. This may help the interaction entity and resource entity to process the one or more interactions and/or to ship the products associated with the one or more interactions to the user exactly on the future time period or another date and time communicated by the resource entity system, thereby improving the efficiency of the interactions while reducing the costs for the interaction entity and/or the resource entity.

As shown in block 765, the system sends the interaction notification to the user computer system of the user before transferring the resource amount to the at least one interaction entity at the future date. As shown in block 770, the system transfers the resource amount from the at least one resource pool of the user to the at least on interaction entity a pre-determined time before the future time period or at the future time period. The system may transfer the resource amount which has been placed on hold in step 745 to the interaction entity. In some embodiments of the present invention, the system transfers the resource amount and credits the supplemental resource amount to the resource pool of the user. For example, the system transfers the transaction amount to the interaction entity and adds the supplemental resource amount calculated by the system in step 730 to the resource account of the user. In alternate embodiments, the system transfers the resource amount reduced by the supplemental resource amount from the resource pool of the user. For example, if the supplemental resource is discount, the system applies the discount to the resource amount thereby generating a new resource amount to be transferred to the interaction entity.

As shown in block 780, the resource entity system in response to receiving the indication of receipt of the resource amount and fulfillment of the one or more interactions, transmits a notification of fulfillment to a user device of the user. For example, the interaction entity may send a receipt of the resource amount and confirmation of the order. Additionally, the interaction entity may send the shipping confirmation, shipment tracking number, and/or the like in the receipt. In embodiments of the present invention, the system may send the indication received from the interaction entity and a separate notification created by the resource entity system to the user. As shown in block 785, the system completes the one or more interactions with the at least one interaction entity at the future time period by updating the interaction list. For example, the system marks the one or more interactions as complete in the interaction list and stores it in the interaction history repository for future reference.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein. In some embodiments, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for facilitating proactive resource acquisition, the system comprising:
one or more memory devices having computer readable code stored thereon; and
one or more processing devices operatively coupled to the one or more memory devices, wherein the one or more processing devices are configured to execute the computer readable code to:
identify one or more interactions for a user and automatically schedule the one or more interactions for a future time period;
identify at least one interaction entity associated with the one or more interactions;
determine resource availability for the one or more interactions before the future time period;
authorize the one or more interactions before the future time period when the resource availability is verified;
allocate a resource amount for the one or more interactions from at least one resource pool of the user;
establish a communication link with the at least one interaction entity associated with the one or more interactions, wherein the communication link is established through at least one interaction entity system;
initiate the one or more interactions by communicating directly with the at least one interaction entity before the future time period without processing the one or more interactions through an interchange network; and
complete the one or more interactions with the at least one interaction entity at the future time period.

2. The system of claim 1, wherein initiating the one or more interactions comprises:
assigning a token to the at least one resource pool of the user to present to the at least one interaction entity in order to complete the one or more interactions.

3. The system of claim 1, wherein completing the one or more interactions with the at least one interaction entity comprises:
transferring the resource amount from the at least one resource pool of the user to the at least one interaction entity before or at the future time period;
receiving an indication of receipt of the resource amount and fulfillment of the one or more interactions from the at least one interaction entity; and
in response to receiving the indication, transmitting a notification of fulfillment of the one or more interactions to a user computer system of the user.

4. The system of claim 3, wherein completing the one or more interactions with the at least one interaction entity further comprises:
applying a supplemental resource amount for supplemental resources to the resource pool of the user, wherein the supplemental resources are specific to the user and associated with the one or more interactions.

5. The system of claim 1, wherein completing the one or more interactions with the at least one interaction entity at the future time period comprises:
transferring the resource amount reduced by a supplemental resource amount from the resource pool of the user, wherein the supplemental resource amount is associated with the one or more interactions and is specific to the user.

6. The system of claim 1, wherein identifying the one or more interactions for the user comprises:
determining that the one or more interactions require an indication from the user for automatically entering into the one or more interactions;
prompting the user on a user computer system to provide the indication for automatically entering into the one or more interactions; and
receiving the indication from the user to allow for automatically entering into the one or more interactions.

7. The system of claim 1, wherein the one or more processing devices are further configured to execute the computer readable code to:
send an initiated interaction notification to a user computer system of the user when the one or more interactions are scheduled;
send a pending interaction notification to the user computer system of the user before meeting the future time period; and
send a completed interaction notification to the user computer system of the user before the meeting the future time period of the interaction.

8. The system of claim 1, wherein the one or more interactions include at least one of one or more desired interactions or one or more suggested interactions.

9. The system of claim 8, wherein the one or more desired interactions are received as an input from the user.

10. The system of claim 8, wherein the one or more suggested interactions are based on the one or more desired interactions, one or more available interactions, and plurality of previous interactions.

11. The system of claim 10, wherein information associated with the one or more available interactions and the plurality of previous interactions is provided by the at least one interaction entity.

12. The system of claim 10, wherein the information associated with the plurality of previous interactions is extracted from a user profile.

13. A computer program product for facilitating proactive resource acquisition, the computer program product comprising at least one non-transitory computer readable medium having computer-readable program code portions embodied therein, the computer-readable program code portions comprising:
an executable portion configured to identify one or more interactions for a user and automatically schedule the one or more interactions for a future time period;
an executable portion configured to identify at least one interaction entity associated with the one or more interactions;
an executable portion configured to determine resource availability for the one or more interactions before the future time period;
an executable portion configured to authorize the one or more interactions before the future time period when the resource availability is verified;
an executable portion configured to allocate a resource amount for the one or more interactions from at least one resource pool of the user;
an executable portion configured to establish a communication link with the at least one interaction entity associated with the one or more interactions, wherein the communication link is established through at least one interaction entity system;
an executable portion configured to initiate the one or more interactions by communicating directly with the at least one interaction entity before the future time period without processing the one or more interactions through an interchange network; and
an executable portion configured to complete the one or more interactions with the at least one interaction entity at the future time period.

14. The computer program product of claim 13, wherein completing the one or more interactions with the at least one interaction entity comprises:
transferring the resource amount from the at least one resource pool of the user to the at least one interaction entity before or at the future time period;
receiving an indication of receipt of the resource amount and fulfillment of the one or more interactions from the at least one interaction entity; and
in response to receiving the indication, transmitting a notification of fulfillment of the one or more interactions to a user computer system of the user.

15. The computer program product of claim 14, wherein completing the one or more interactions with the at least one interaction entity further comprises:
applying a supplemental resource amount for supplemental resources to the resource pool of the user, wherein the supplemental resources are specific to the user and associated with the one or more interactions.

16. The computer program product of claim 13, wherein completing the one or more interactions with the at least one interaction entity at the future time period comprises:
transferring the resource amount reduced by a supplemental resource amount from the resource pool of the user, wherein the supplemental resource amount is associated with the one or more interactions and is specific to the user.

17. A computer implemented method for facilitating proactive resource acquisition, the computer implemented method comprising:
identifying one or more interactions for a user and automatically schedule the one or more interactions for a future time period;
identifying at least one interaction entity associated with the one or more interactions;
determining resource availability for the one or more interactions before the future time period;
authorizing the one or more interactions before the future time period when the resource availability is verified;
allocating a resource amount for the one or more interactions from at least one resource pool of the user;
establishing a communication link with the at least one interaction entity associated with the one or more interactions, wherein the communication link is established through at least one interaction entity system;
initiating the one or more interactions by communicating directly with the at least one interaction entity before the future time period without processing the one or more interactions through an interchange network; and
completing the one or more interactions with the at least one interaction entity at the future time period.

18. The computer implemented method of claim 17, wherein completing the one or more interactions with the at least one interaction entity comprises:
transferring the resource amount from the at least one resource pool of the user to the at least one interaction entity before or at the future time period;
receiving an indication of receipt of the resource amount and fulfillment of the one or more interactions from the at least one interaction entity; and
in response to receiving the indication, transmitting a notification of fulfillment of the one or more interactions to a user computer system of the user.

19. The computer implemented method of claim 18, wherein completing the one or more interactions with the at least one interaction entity further comprises:
applying a supplemental resource amount for supplemental resources to the resource pool of the user, wherein the supplemental resources are specific to the user and associated with the one or more interactions.

20. The computer implemented method of claim 17, wherein completing the one or more interactions with the at least one interaction entity at the future time period comprises:
transferring the resource amount reduced by a supplemental resource amount from the resource pool of the user, wherein the supplemental resource amount is associated with the one or more interactions and is specific to the user.
